(19) United States
(12) Patent Application Publication
(10) Pub. No.: US 2026/0276347 A1
(43) Pub. Date: Sep. 17, 2026

(54) DESIGNATION SYSTEM COMPRISING AN APPARATUS FOR TRACKING A DESIGNATION OF AT LEAST ONE TARGET

(71) Applicant: SAFRAN ELECTRONICS & DEFENSE, PARIS (FR)

(72) Inventors: Vincent MARIE, MOISSY-CRAMAYEL (FR); Gautier LAGARDE, MOISSY-CRAMAYEL (FR); Coraline SIBERT, MOISSY-CRAMAYEL (FR)

(21) Appl. No.: 19/118,572

(22) PCT Filed: Oct. 4, 2023
(86) PCT No.: PCT/EP2023/077503

§ 371 Date: Apr. 4, 2025

(30) Foreign Application Priority Data
Oct. 6, 2022 (FR) FR2210246

(51) Int. Cl. F41G 7/22; F41G 3/14; G06T 7/70; H04N 23/55; H04N 23/60

(52) U.S. Cl. CPC F41G 7/226; F41G 3/145; F41G 7/2293; G06T 7/70; H04N 23/55; H04N 23/60; G06T 2207/30204

(57) ABSTRACT

A designation system includes a laser designator and an apparatus for tracking a designation of a target. The apparatus includes an optronic device (4) having an optical imaging sensor (5), the sensor being an on-silicon sensor, and the apparatus has sensor control means capable of modifying at least one parameter of the sensor in order, during operation, to image at least one designation mark generated by the laser designator per predetermined given time interval, which repeats periodically, the apparatus being asynchronous with the laser designator.

The invention relates to a designation system comprising an apparatus for tracking a designation of at least one target by at least one laser designator.

### BACKGROUND OF THE INVENTION

In the military field, it is now known to guide a munition (missile or bomb) using a laser designator. This type of guidance is called semi-active laser guidance (SAL).

The laser designator emits brief laser pulses that, when directed at a given target, generate a designation mark for the target.

The main features of a laser designator are as follows:
its emission wavelength (typically equal to 1064 nanometres),
the energy emitted per pulse (typically greater than or equal to 50 millijoules),
the duration of a pulse (typically a few tens of nanoseconds),
the pulse repetition period.

Guidance is ensured by using the designation mark.

For this purpose, two types of apparatuses comprising an optronic device that detects the designation marks are known, namely:
apparatuses mounted directly on the munitions so that the munition in question can reach the target designated by way of the designation marks,
apparatuses remote from the munitions for ensuring that the designation marks are indeed on the intended target.

In both cases, however, the nature of the laser radiation generated by the laser designator (wavelength, short and repetitive pulses, etc.) imposes multiple constraints on the detection of the designation marks.

In particular, the apparatus has to be sensitive to the particular wavelength specific to the laser designator and be able to handle the pulsed nature of the laser designator, which implies that the designation mark is only intermittently in existence.

Thus, the apparatus usually comprises an InGaAs camera (indium gallium arsenide) associated with an external synchronisation device. The apparatus causes the camera to capture an image when a designation mark is present, by synchronising the taking of the image by the camera with the generation of a laser pulse by the designator:
either by using the emission timing diagram of the laser designator as a basis (in the case of a collaborative system),
or by associating a non-imaging detection device of the laser designator, such as a laser spot tracker or an event detection sensor, with the synchronisation device.

However, these techniques are expensive and complex to implement.

### OBJECT OF THE INVENTION

An object of the invention is to propose a simplified designation system for tracking a designation of a target by at least one laser designator.

### SUMMARY OF THE INVENTION

To achieve this object, an asynchronous system for designating at least one target is proposed, comprising at least one laser designator associated with at least one designation tracking apparatus, the apparatus comprising:
an optronic device having:
   at least one optical imaging sensor and
   at least one imaging optic suitable for directing light rays onto a sensitive surface of the sensor,
a processing unit configured to analyse data transmitted by the sensor in order to determine a position of at least one designation mark generated by a laser designator intended to be associated with the designation tracking apparatus,
the sensor being an on-silicon sensor, the apparatus comprising sensor control means capable of modifying at least one parameter of the sensor in order, during operation, to image at least one designation mark generated by the laser designator per predetermined given time interval, said interval being repeated periodically,
the apparatus being asynchronous with the laser designator.

The inventors have found that the invention allows the designation of a laser designator to be accurately tracked. Advantageously, the invention does not have an external synchronisation device and can operate without needing the emission timing diagram of the laser designator.

The invention is thus simple.

Furthermore, the invention is relatively inexpensive.

Optionally, the sensor is a complementary metal-oxide semiconductor sensor (CMOS).

Optionally, the apparatus comprises at least one spectral filtering device arranged upstream of the sensor and suitable for increasing, during operation, a ratio between radiation intensity received from the laser designator and radiation intensity received from the surrounding environment.

Optionally, the spectral filtering device is a spectral filtering device having a variable spectral width and/or variable attenuation.

Optionally, the spectral filtering device is arranged upstream of the imaging optic and/or inside the imaging optic.

Optionally, the control means execute at least one servo loop in order to modify the at least one parameter of the sensor on the basis of at least the data transmitted by the sensor.

Optionally, the control means also control the spectral filtering device.

Optionally, the parameter modified by the control means is an integration time of the sensor and/or an image period of the sensor.

Optionally, the sensor comprises a function that allows the sensor to have a plurality of integration times.

For example, the sensor comprises an intra-frame acquisition function.

For example, the sensor comprises a high dynamic range inter-frame acquisition function.

Optionally, the laser designator is remote from the tracking apparatus, or the tracking apparatus is borne by the same support as the laser designator.

Optionally, the system is configured to acquire a target image including a designation mark and a scene image and to merge the two images.

Optionally,
the sensor comprises a function allowing for a plurality of integration times during the same image period of the sensor,
and/or
the control means execute at least one servo loop in order to modify the at least one parameter of the sensor (5) on the basis of at least the data transmitted by the sensor so as to modify at least one integration time (Tint) of the sensor such that the laser pulse repetition periods (PRP) of the laser designator (2) are not included in the problematic cases defined by the following equation:

$$PRP ∈ {⋃}_{i = 1}^{α} ( {⋃}_{j = 1}^{i} [ k + \frac{j}{i} \times {T}_{frame} - ε ; k + \frac{j}{i} \times {T}_{frame} + ε ] ) \qquad ( 1 )$$

where kϵ [symbol] ,
αϵ [symbol] , and
ε=(Tframe−Tint)/ΔTmax×Tframe where Tint is the integration time of the sensor, Tframe is the frame time of the sensor and ΔTmax is the predetermined given time interval.

Optionally, the spectral filtering device has a variable spectral width and comprises at least one ascending high-pass filter and at least one low-pass cutoff filter, the processing unit executing a servo loop in order to control the spectral filtering device on the basis of the analysis of the images transmitted by the sensor.

By way of example, the processing unit executes a servo loop in order to control the spectral filtering device on the basis of the analysis of the images transmitted by the sensor by acting on the value of the wavelength of at least one of the filters.

For example, the processing unit controls the spectral filtering device so as to be able to act on the value of the wavelength of at least one of the filters depending on the illumination level in the surrounding environment as detected in the images transmitted by the sensor.

Other features and advantages of the invention will become clear on reading the following description of particular and non-limiting embodiments of the invention.

### BRIEF DESCRIPTION OF THE DRAWINGS

The invention will be better understood in the light of the following description, which is given with reference to the accompanying drawings, in which:

FIG. 1 schematically shows a designation system according to a particular embodiment of the invention;

FIG. 2 is a diagram characterising a first version of a filter associated with a sensor of the system shown in FIG. 1;

FIG. 3 is a diagram characterising a second version of a filter associated with a sensor of the system shown in FIG. 1;

FIG. 4a is a timing diagram schematically showing the image periods of a sensor of the system shown in FIG. 1 as well as the time at which laser pulses are generated by the laser designator of said apparatus;

FIG. 4b is a timing diagram schematically showing the phase shift between the image periods and the time at which the laser pulses are generated, for two successive pulses, in accordance with what has already been indicated in FIG. 4a;

FIG. 5 is a timing diagram schematically showing the phase shift between two integration times during the same image period of a sensor of the system shown in FIG. 1;

FIG. 6 is a timing diagram schematically showing the phase shift between two integration times during several image periods of a sensor of the system shown in FIG. 1, in accordance with a specific control strategy possibility for said sensor;

FIG. 7 is a timing diagram schematically showing the phase shift between two integration times during the same image period of a sensor of the system shown in FIG. 1, in accordance with a different specific control strategy for said sensor;

FIG. 8 schematically shows an example of a first possible arrangement of a designation tracking apparatus of the system shown in FIG. 1;

FIG. 9 schematically shows an example of a second possible arrangement of a designation tracking apparatus of the system shown in FIG. 1;

FIG. 10 schematically shows an example of a third possible arrangement of a designation tracking apparatus of the system shown in FIG. 1;

FIG. 11 is a timing diagram schematically showing an image period of a sensor of the system shown in FIG. 1.

### DETAILED DESCRIPTION OF THE INVENTION

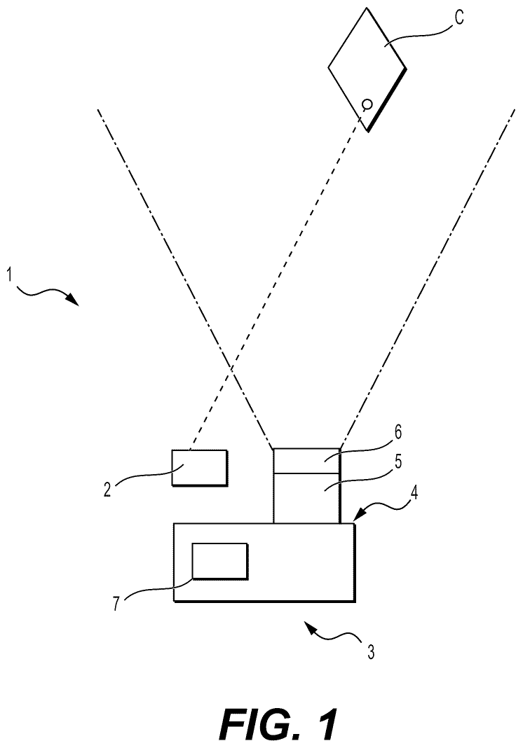

With reference to FIG. 1, a system 1 for designating at least one target C according to a particular embodiment of the invention comprises a laser designator 2 and an apparatus 3 for tracking a designation of the target C using: said laser designator 2. By way of example, the laser designator is a military laser designator.

The system 3 comprises an optronic device 4 having an optical imaging sensor 5.

The optronic device 4 also comprises at least one imaging optic 6 suitable for focusing light rays at the input of the optronic device 4 onto a sensitive surface of the sensor 5.

The system 3 also comprises a processing unit 7 that is connected to the optronic device 4. By way of example, the processing unit 7 is a processor, a microprocessor, a computing machine, a micro-computing machine, a microcomputer, etc.

The processing unit 7 is capable of executing one or more servo loops in order to control the optronic device 4, in particular the sensor 5 and/or one or more spectral filtering devices of the optronic device 4, in particular on the basis of data supplied by the sensor 5, as will be seen below.

During operation, the laser designator 2 generates laser pulses which, when they come into contact with the target C, cause designation marks to appear on the target. In particular, the laser designator 2 generates brief laser pulses. By way of example and in a non-limiting manner, the laser designator 2 generates laser pulses lasting approximately several tens of nanoseconds, for example approximately ten nanoseconds, and for example between 8 and 12 nanoseconds.

It is thus understood that the designation marks appear at a frequency corresponding to the emission frequency of the laser pulses. The laser designator 2 here has an emission wavelength of substantially 1064 nanometres (nm). “Substantially” should be construed to mean that the emission wavelength of the laser designator is 1064 nanometres plus or minus 20 nanometres, for example plus or minus 10 nanometres, for example plus or minus 1 nanometre, for example plus or minus 0.4 nanometres, and for example plus or minus 0.1 nanometres.

The wavelength of the emitted laser pulses has a wavelength band sensed by the optronic device 4 such that the designation marks are transmitted by the imaging optic 6 and sensed by the sensor 5. The sensor 5 thus generates target images related to the designation marks (or generates information for allowing said designation marks themselves to generate target images related to the designation marks at, for example, the processing unit 7; to simplify the rest of the description, it is noted here that the imaging optic 6 is suitable for forming at least one target image on the sensitive surface of the sensor 5 and that the sensor 5 supplies target images directly to the processing unit 7).

On this basis, the processing unit 7 can analyse the target images in order to estimate a position of the designation marks with respect to the target C:
either because the designation mark and the target C are visible at the same time in the same target image;
or because the images supplied by the optronic device 4 intermittently show a target image comprising the laser mark and an image in which the target C alone is visible, the processing unit 7 being able to merge these images;
or because the processing unit 7 merges the target images supplied by the optronic device 4 with images, in which the target C is visible, supplied by an imaging route of the system 1 other than the optronic device 4 (the other imaging route may or may not be part of the system 1).

This makes it possible to ensure that the laser designator 2 tracks the designation of the target C.

Furthermore, the sensor 5 is an on-silicon sensor.

For example, the sensor 5 is an on-silicon CMOS sensor.

This is particularly advantageous because of the emission wavelength of the laser designator 2.

An on-silicon sensor is naturally sensitive to the 1064-nm emission wavelength of the laser designator 2. In fact, over the spectral range between 400 nm and 1100 nm, the greater the thickness of an epitaxial layer of an on-silicon sensor, the greater the proportion of incident photons at a wavelength of 1064 nm detected by the sensor.

The inventors have thus been able to find commercially available on-silicon sensors having a sensitivity of up to 1100 nm, which makes them compatible with detecting laser marks generated by the laser designator 2. Such sensors are also less expensive than those usually used, such as InGaAs sensors.

The sensor 5 is thus capable of sensing an optical signal in a wavelength band comprising the emission wavelength of the laser designator 2 of substantially 1064 nm.

Preferably, the system 3 comprises at least one spectral filtering device 9 associated with the sensor 5 in order to optimise the sensitivity thereof to detecting the designation marks.

The spectral filtering device 9 is arranged upstream of the sensor 5 (i.e. between the target C and the sensor 5). By way of example, as can be seen in FIGS. 8, 9 and 10, the spectral filtering device 9 is arranged upstream of the imaging optic 6 and/or within the imaging optic 6 and/or downstream of the imaging optic between the imaging optic 6 and the sensor 5. For example, the system 3 comprises a plurality of spectral filtering devices 9 associated with the sensor 5: a first one upstream of the imaging optic 6, a second one within the imaging optic 6 and a third one downstream of the imaging optic 6 between the imaging optic 6 and the sensor 5.

The following description of a spectral filtering device 9 is applicable to the other spectral filtering devices.

The inventors have found it advantageous to associate the sensor 5 with at least one spectral filtering device 9 that limits the light radiation sensed by the sensor 5 from the ambient illumination.

Preferably, the system comprises a spectral filtering device 9 that is suitable for increasing a ratio between radiation intensity received from the laser designator 2 and radiation intensity received from the surrounding environment.

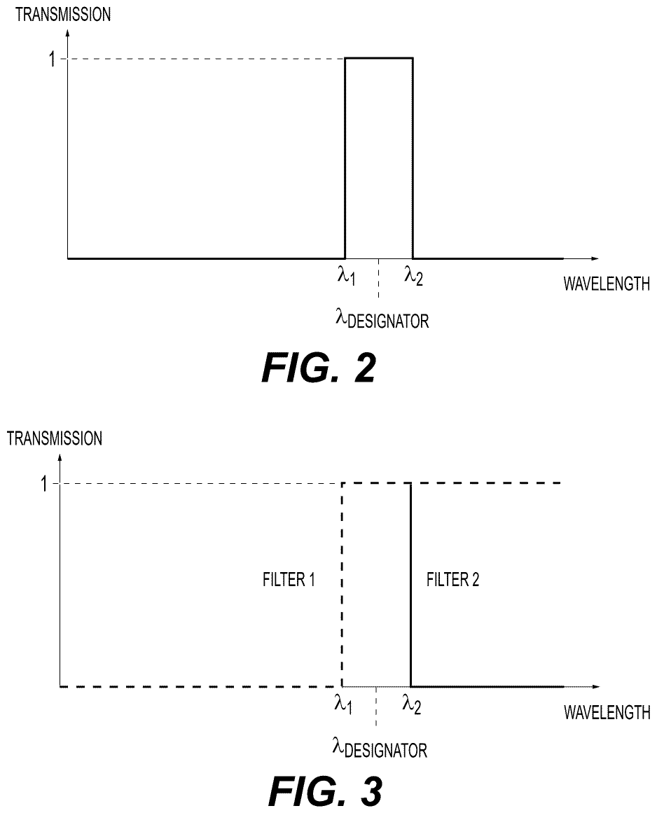

With reference to FIG. 2, according to a first version, the spectral filtering device 9 is a spectral filtering device 9 which comprises (or is) a band-pass filter for blocking, or at least limiting, radiation with a wavelength outside the range [λ1; λ2], with λ1 and λ2 thus allowing the filter to be characterised.

The spectral filtering device 9 has a “fixed” spectral width, i.e. the spectral width of said device (characterised by the range [λ1; λ2]) is fixed. The inventors have found it particularly advantageous to use a spectral filtering device 9 that always includes the emission wavelength of the laser designator 2.

This makes it possible to reduce the radiation sensed by the sensor 5 from the surrounding environment but without reducing the radiation from the laser designator 2. This allows the sensor 5 to detect the designation marks more easily and accurately.

The range [λ1; λ2] is selected so that said range includes the emission wavelength of substantially 1024 nm of the laser designator 2 (hereinafter referred to as λ_{designator}).

Preferably, the range [λ1; λ2] is selected so that said range is centred on λ_{designator}.

Preferably, the range [λ1; λ2] is selected so as to be a narrow range. Specifically, the narrower the range [λ1; λ2], the greater the ability of the band-pass filter to limit radiation from the surrounding environment. A wavelength range is considered narrow when it is, for example, less than 100 nm, for example less than 50 nm, and for example less than 30 nm.

The wavelength range depends, inter alia, on:
the manufacturing tolerance of the spectral filtering device 9,
the incidence of light rays reaching the optronic device 4,
potential laser emission lines over the operating temperature range of the laser designator 2, said lines being related to the properties of the crystal used in the laser designator 2.

Preferably, regardless of the range [λ1; λ2], the spectral filtering device 9 is removable.

As a result, the spectral filtering device 9 can be used only when the light intensity of the surrounding environment has to be reduced.

With reference to FIG. 3, according to a second version, the spectral filtering device 9 comprises (or is) a band-pass filter for blocking, or at least limiting, radiation with a wavelength outside the range [λ1; λ2], with λ1 and λ2 allowing the filter to be characterised. The spectral filtering device 9 has a “variable” spectral width, i.e. the spectral width of said device (characterised by the range [λ1; λ2]) is variable. The spectral filtering device 9 thus makes it possible to modify the value of λ1 and/or λ2 and/or the rejection rate of the filter outside the range [λ1; λ2].

For example, the spectral filtering device 9 comprises at least one ascending high-pass filter at λ1 and at least one low-pass cutoff filter at λ2. Thus, by acting on λ2 and/or λ1 (by means of a mechanical device, for example), the width of the transmission band λ2-λ1 can be modified. For example, the mechanical device (which may or may not be part of the spectral filtering device 9) may:
modify the gradient of the ascending high-pass filter at λ1 and/or the low-pass cutoff filter at λ2 in order to modify these wavelengths,
and/or
use sets of filters (the set comprising a plurality of ascending high-pass filters with different features and/or a plurality of low-pass cutoff filters with different features) in order to modify these wavelengths, for example by replacing one filter with another or by combining the filter in situ with at least one other filter.

The inventors have found it particularly advantageous to use a spectral filtering device 9 that always includes the emission wavelength of the laser designator 2.

This makes it possible to reduce the radiation sensed by the sensor 5 from the surrounding environment but without reducing the radiation from the laser designator 2. This allows the sensor 5 to detect the designation marks more easily and accurately.

Therefore, the range [λ1; λ2] is preferably selected so that said range includes the emission wavelength of substantially 1024 nm of the laser designator 2 (hereinafter referred to as λ_{designator}).

Preferably, the range [λ1; λ2] is selected so that said range is centred on λ_{designator}.

Preferably, the range [λ1; λ2] is selected so as to be a narrow range. Specifically, the narrower the range [λ1; λ2], the greater the ability of the band-pass filter to limit radiation from the surrounding environment. A wavelength range is considered narrow when it is, for example, less than 100 nm, for example less than 50 nm, and for example less than 30 nm.

The wavelength range depends, inter alia, on:
the manufacturing tolerance of the spectral filtering device 9,
the incidence of light rays reaching the optronic device 4,
potential laser emission lines over the operating temperature range of the laser designator 2, said lines being related to the properties of the crystal used in the laser designator 2.

Preferably, regardless of the range [λ1; λ2], the spectral filtering device 9 is removable.

As a result, the spectral filtering device 9 can be used only when the light intensity of the surrounding environment has to be reduced.

Having a spectral filtering device 9 that has a variable spectral width makes it possible not to be too limited when selecting the width of the transmission band, in particular with regard to the value of λ1 and/or λ2. This is particularly advantageous because it means the value of the width of the transmission band can be adapted depending on the illumination level in the surrounding environment and/or it can allow the sensor to generate different types of images, such as an image of the surrounding environment (the “scene image”) and an image of the designation mark (the “target image”).

Preferably, the processing unit 7 executes a servo loop in order to control the spectral filtering device 9 having the variable spectral width on the basis of the analysis of the images transmitted by the sensor 5. For example, the processing unit 7 controls the spectral filtering device 9 so as to be able to act on the values λ1 and λ2 depending on the level of illumination in the surrounding environment as detected in the images transmitted by the sensor 5.

For example, the servo loop is defined such that the spectral filtering device 9 having the variable spectral width can limit saturation of the sensor 5 as much as possible while maintaining a level of light radiation from the surrounding environment, which can be used in the event that the target C and the designation mark can be viewed in the same image.

On the other hand, if the optronic device 4 intermittently acquires scene images comprising the target C and also target images, the servo loop accordingly modifies one or more features of the spectral filtering device 9 depending on the image to be acquired.

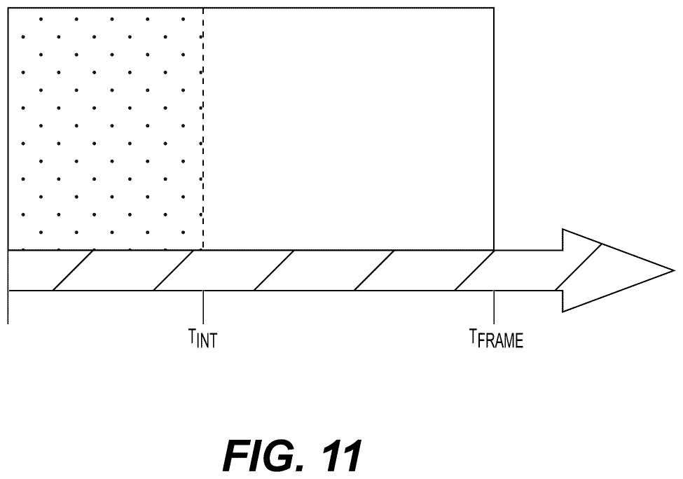

In another aspect, as can be seen more clearly in FIG. 11, it is noted that for an optical sensor, it is necessary to distinguish between the integration time Tint, which gives the time interval during which the sensitive surface of the sensor is active, and the frame time Tframe, which includes said integration time Tint and also the transmission time of information acquired during Tint in order to generate an image on the basis of that information. Consequently, Tframe defines the period of time between two successive images, and Tint defines the time window in which the sensitive surface of the sensor is active.

Usually, Tint starts at the same time as Tframe.

In the case in hand, the laser pulses generated by the laser designator 3 are very brief. Consequently, if one of the laser pulses of the laser designator 2 is generated between two successive integration times Tint of the sensor 5, the corresponding designation mark will not be imaged by the optronic device 4.

Preferably, the system 1 comprises means 10 for controlling the sensor 5, which are capable of modifying, during operation, at least one parameter of the sensor 5 so that the sensor can image a designation mark, generated by the laser designator, at least once per predetermined given time interval.

It should be noted that the laser designator 2 generates a plurality of laser pulses per second, typically 5 or more laser pulses per second. Accordingly, for the designation tracking mission to be successful, it is not necessary to image each laser pulse generated by the laser designator 2. However, it should be ensured that at least one designation mark can be imaged during a predetermined given time interval (hereinafter denoted ΔTmax), i.e. that at least one laser designation mark is imaged during ΔTmax.

The predetermined given time interval ΔTmax is, for example, less than 2 seconds, for example less than 1 second. The predetermined given time interval ΔTmax therefore has to be construed as a time window whose duration is fixed and which is triggered after a laser pulse sensed by the optronic device 4.

By way of example, the control means 10 are integrated in the processing unit 7.

In particular, it is advisable for the control means 10 to be able to act on the integration time Tint and/or Tframe of the sensor 5 to ensure that at least one designation mark can be imaged per predetermined given time interval ΔTmax.

If the system 1 were synchronous, then the instant at which laser pulses are generated by the laser designator 2 would be known to the control means 10. For example, the laser designator 2 would be connected to the apparatus 3, for example to the processing unit 7.

The processing unit 7 would then control the sensor 5 such that the integration time Tint would start at the instant at which the laser designator 2 generates a laser pulse (the predetermined given time interval ΔTmax then being equal to Tframe), Tint being defined so as to cover the time needed for the laser pulse to travel from the laser designator 2 to the target C (located at a distance D from the sensor 5) before returning to the optical device 4.

Considering the particular case of FIG. 1, in which the laser designator 2 and the apparatus 3 are at a similar distance D from the target C (for example because they are borne by the same support and are therefore co-located), Tint would be defined by the following formula:

$$D = Tint \times {c}_{0} / ( 2 \times n )$$

where c₀ designates the speed of light in a vacuum,
where n designates the refractive index of the medium in which the laser pulses propagate, at the emission wavelength of the laser designator 2.

In another case in which the laser designator 2 and the apparatus 3 are not at the same distance from the target C (for example because they are borne by two different supports and are therefore not co-located), Tint would then be defined by the following formula:

$$D 1 + D 2 = Tint \times {c}_{0} / n$$

where D1 designates the distance between the target C and the laser designator 2,
where D2 designates the distance between the target C and the apparatus 3.

The parameter of the sensor 5 that can be modified by the control means 10 would be at least the integration time Tint of said sensor.

According to a first variant, the integration time Tint could be started not at each instant when the laser designator 2 generates a laser pulse but at intervals based on the frequency of the laser pulses (for example, the integration time Tint would only start once every second laser pulse at the time the second laser pulse is generated, the predetermined given time interval ΔTmax then being equal to 2*Tframe).

According to a second variant (which can optionally be combined with the first variant), the integration time Tint would start not at the time a laser pulse is generated but after a predefined latency interval. This could thus make it possible to limit saturation of the sensitive zone of the sensor 5 by backscattering the laser pulse at the beginning of its propagation.

Thus, according to one possibility of this second variant, if Tint had to be minimised, the integration time Tint could be started after a time dT which follows the emission of a laser pulse, such that:

$$( dT \times {c}_{0} / n ) < ( D 1 + D 2 )$$

Nevertheless, according to the invention, the system 1 is asynchronous. The laser designator 2 here is an external laser designator and is therefore not connected to the apparatus 3 or to the processing unit 7 of the apparatus 3. In this way, the means for controlling the sensor 5 do not know the instant at which laser pulses are generated by the laser designator 2.

The solution proposed for the case where the system 1 is synchronous is therefore not applicable here. Consequently, two other possibilities will now be described.

### First Possibility

Noting t_{LAS,Dn} as the instant of the nth laser pulse detected by the sensor 5 (via the designation mark) and t_{LAS,Dn+i} as the instant thereafter, the relationship should be as follows:

$${t}_{LAS , Dn + 1} - {t}_{LAS , Dn} \leq Δ T max$$

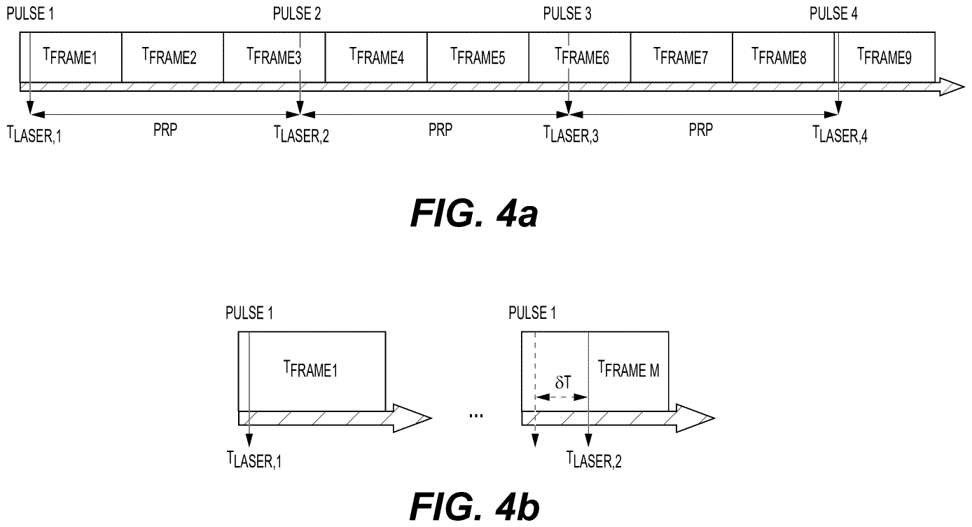

It is thus necessary to be able to characterise the phase shift between the laser pulses generated by the laser designator 2 and the taking of images by the optronic device 4, as can be seen in FIG. 4a.

With reference to FIG. 4b, considering that two successive laser pulses are separated by M frames (i.e. a frame being defined in time by a single image period Tframe), the induced phase shift δt is defined as the remainder of the Euclidean division of the laser pulse repetition period (PRP) by the image period Tframe:

$$PRP = M \times Tframe + δ t$$

Through correlation between the frame time Tframe and the PRP, the probability that at least one designation mark can be imaged during ΔTmax is significant.

In practice, the cases deemed problematic (i.e. no designation mark will be imaged during one or more ΔTmax) can be identified as follows:
if Tframe>Tint≥Tframe/2, then the problematic cases are PRPϵ[k×Tframe−ε; k×Tframe+ε], where k ϵ [symbol] and ε is defined by ε=(Tframe−Tint)/ΔTmax×Tframe;
if Tframe/2>Tint≥Tframe/3, then in addition to the problematic cases identified above, there are new symptomatic cases PRPϵ[(k+1/2)×Tframe−ε; (k+1/2)×Tframe+ε];
if Tframe/3>Tint≥Tframe/4, then in addition to the problematic cases identified above, there are new symptomatic cases PRPϵ[(k+1/3)×Tframe−ε; (k+1/3)×Tframe+ε]U[(k+2/3)×Tframe−ε; (k+2/3)×Tframe+ε];
etc.

In general, for a given PRP, a given image period Tframe and a given integration time Tint, such that:

$$Tint = Tframe / ( α + 1 ) + β$$

$$where α ∈ ℕ * ,$$

$$and β < Tframe / ( α ) - Tframe / ( α + 1 ) ,$$

the problematic cases are:

$$PRP ∈ {⋃}_{i = 1}^{α} ( {⋃}_{j = 1}^{i} [ k + \frac{j}{i} \times {T}_{frame} - ε ; k + \frac{j}{i} \times {T}_{frame} + ε ] ) \qquad ( 1 )$$

$$where k ∈ ℕ , and$$

$$ε = ( Tframe - Tint ) / Δ T max \times Tframe .$$

Since the list of possible PRPs is known and discrete, the asynchronous display of the designation marks generated by the laser designator 2 is optimised by adopting a servocontrol of the integration time Tint and/or of the image period Tframe.

For this purpose, the servo system calculates at least one parameter of the sensor 5 (at least Tint and preferably Tint together with Tframe) depending on the target images while ensuring that the condition of equation (1) is adhered to for the list of possible PRPs—a list that is known and discrete.

The processing unit 7 thus executes a servo loop in order to modify the integration time Tint, and possibly the image period Tframe of the sensor, so that the PRPs in the continuous, discrete list of PRPs of the laser designator 2 are not included in the problematic cases defined by equation (1). For this purpose, the processing unit 7 relies on the target images supplied by the sensor 5, ensuring in particular that one designation mark is clearly visible for each ΔTmax.

For the case in hand, the parameter of the sensor 5 that can be modified by the control means is at least its integration time Tint, optionally together with its image period Tframe.

FIG. 8 shows an example configuration of the apparatus 3 according to this first possibility.

The optical flow F reaching the apparatus 3 passes through the optronic device 4 (optionally while passing through one or more spectral filtering devices 9) before reaching the sensor 5.

This makes it possible to generate a target image 11, which is analysed by the processing unit 7 (for example by image analysis means 12 of the processing unit 7). On this basis, the control means 10 deduce a control setpoint for at least one of the spectral filtering devices 9 and/or the sensor 5 (to define therefrom, for example, the integration time Tint and possibly the image period Tframe).

### Second Possibility

In this second possibility, the sensor 5 is a sensor 5 comprising an intra-frame acquisition function, for example comprising a “high dynamic range” (HDR) intra-frame acquisition function. A function of this kind allows for a plurality of integration times (during which the sensitive surface of the sensor is active) during the same image period; in this way, a plurality of images can be generated during the same image period.

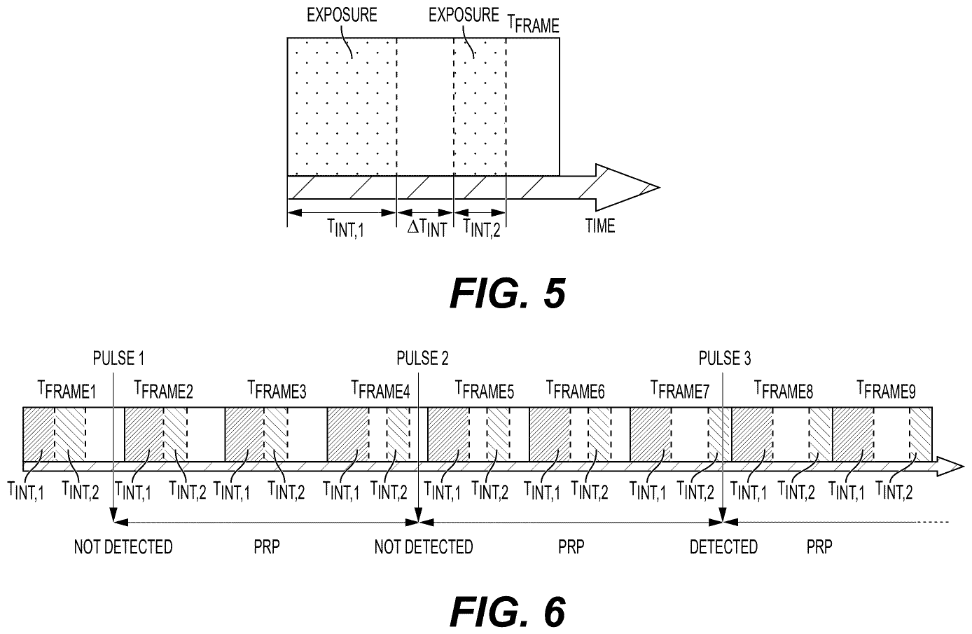

With reference to FIG. 5, the sensor 5 makes it possible, for example, to have two different integration times Tint1 and Tint2 during the same image period Tframe. Tint1 and Tint2 may have identical or different values, and they also have a phase shift, denoted as ATint, which may optionally be zero. Usually, Tint1 starts at the same time as Tframe.

This is a non-limiting example, and the sensor 5 could be configured to have a greater number of different integration times during the same image period.

With this type of sensor, different strategies can be put in place to ensure that at least one designation mark is imaged during the predetermined given time interval ΔTmax.

The following strategies can be applied either individually or in a combination of at least one strategy with at least one other strategy.

It goes without saying that the following strategies are applicable to a greater number of integration times per image period than two.

It also goes without saying that the following strategies are applicable to the second possibility alone or to the case where the first possibility is combined with the second possibility.

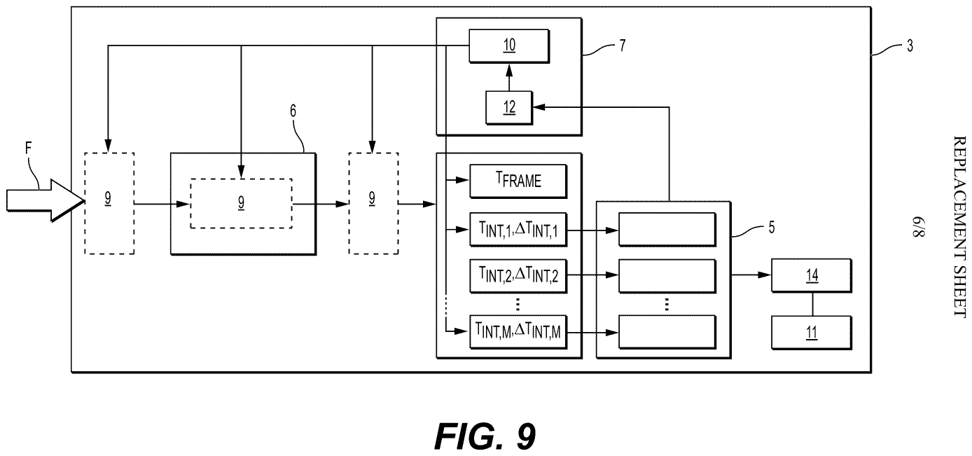

FIG. 9 shows an example configuration of the system according to this second possibility.

The radiation reaching the apparatus 3 passes through the optronic device 4 (optionally while passing through one or more spectral filtering devices) before reaching the sensor 5.

This makes it possible to generate a plurality of target images 13, each target image being linked to an integration time Tinti of the same image period Tframe.

On the one hand, these different images are merged by an image processing element 14 to obtain a single target image 11 associated with a single image period Tframe.

On the other hand, these different images are analysed by the processing unit 7. On this basis, the control means 10 deduce a control setpoint for at least one of the spectral filtering devices 9 and/or the sensor 5 (to define therefrom, for example, at least one of the integration times Tinti and optionally the image period Tframe).

### First Strategy

The control means 10 define the integration times Tint1 and Tint2 so as to cover the entire image period Tframe. Thus:

$$Tint 1 + Tint 2 = Tframe and Δ Tint = 0$$

As a result, an image of each designation mark will inevitably be acquired by the sensor 5.

ΔTmax is then equal to Tframe.

Optionally, the integration times Tint1 and Tint2 do not have the same value. By way of example, one is a long integration time and the other is a short integration time, i.e. the short integration time is at least 1.5 times shorter than the long integration time, for example at least 2 times shorter. For example, Tint1 is a long integration time and Tint2 is a short integration time.

In this first strategy, the processing unit 7 therefore does not execute a servo loop in order to modify the integration time Tint1 and/or Tint2 and/or the image period Tframe of the sensor 5.

### Second Strategy

The control means 10 define the period ΔTint between the two integration times Tint1 and Tint2 such that ΔTint is modified every N frames. By way of example, N is between 2 and 6 and is, for example, equal to 3 (as in the example of FIG. 6).

N is thus selected to get rid of symptomatic cases where the PRP is a multiple of the image period, i.e. to get rid of the PRP_{SYMPTOMATIC} that are defined by equation (1).

In this case, the control means 10 define:

$$N = {PRP}_{SYMPTOMATIC} / Tframe$$

by increasing ΔTint by the quantity Tint2 every N frames (α),
and adhering to the following condition:

$$Tint 2 \geq N \times Tframe \times ( Tframe - Tint 1 ) / ( Δ T max + N \times Tframe ) ( β ) .$$

Optionally, the processing unit 7 thus executes a servo loop in order to modify the integration time Tint1 and/or Tint2 and/or the image period Tframe of the sensor 5 so as to avoid PRP_{SYMPTOMATIC} While adhering to the aforementioned conditions (α) and (β). For this purpose, the processing unit 7 relies on the target images supplied by the sensor 5, ensuring in particular that one designation mark is clearly visible for each ΔTmax.

### Third Strategy

The control means 10 define the period ΔTint and the two integration times Tint1 and Tint2 such that the end of the second integration time Tint2 coincides with the end of the image period Tframe.

For this purpose, the control means 10 use the following formulas:

$$Tint 1 + Tint 2 \geq Tframe / 2$$

$$and Δ Tint = Tframe - ( Tint 2 + Tint 1 ) .$$

This makes it possible to reduce the range of symptomatic PRPs, identified beforehand with equation (1), to:

$$PRP ∈ [ k \times Tframe - ε ; k \times Tframe + ε ] \qquad ( {1}^{′} )$$

$$where k ∈ ℕ$$

$$and$$

$$ε = [ Tframe - ( Tint 1 + Tint 2 ) ] / Δ T max \times Tframe .$$

The processing unit 7 thus executes a servo loop in order to modify the integration time Tint1 and/or Tint2 and/or the image period Tframe of the sensor 5 such that the PRPs of the laser designator 2 are not included in the problematic cases defined by equation (1′) while adhering to the aforementioned formulas Tint1+Tint2≥Tframe/2 and ΔTint=Tframe−(Tint2+Tint1). For this purpose, the processing unit 7 relies on the target images supplied by the sensor 5, ensuring in particular that one designation mark is clearly visible for each ΔTmax.

### Fourth Strategy

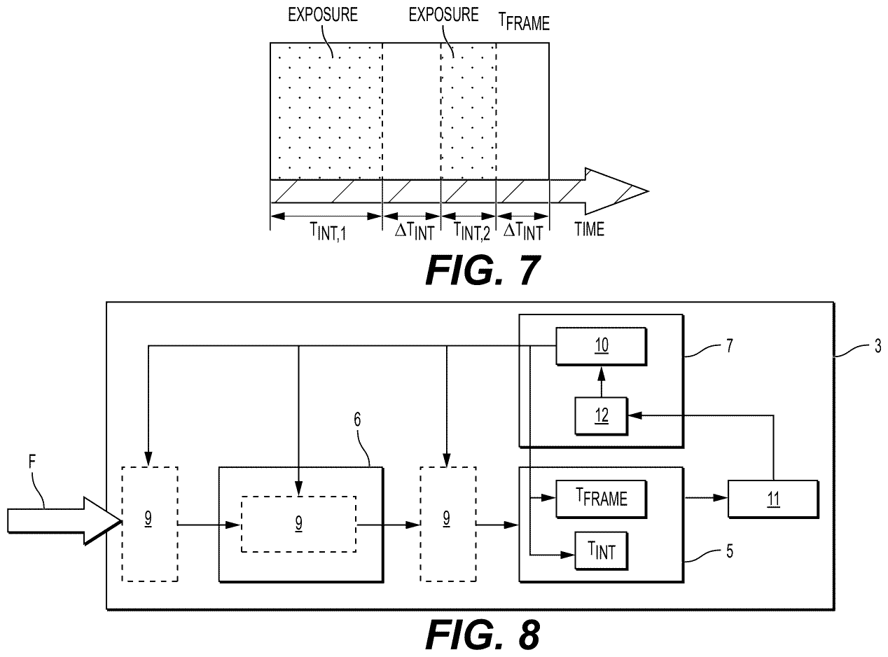

The control means 10 define the integration times Tint1 and Tint2 such that the integration time Tint2 is centred on the “blind zone” of the image period Tframe (i.e. the time interval of Tframe not covered by Tint1), thus defining two blind zones of equal duration on either side of Tint2, as can be seen in FIG. 7.

For this purpose, the control means 10 rely on the following formula:

$$Δ Tint = Tframe - ( Tint 2 - Tint 1 ) / 2.$$

This makes it possible to limit ε in equation (1) to:

$$ε = [ Tframe - ( Tint 1 + Tint 2 ) ] / ( 2 \times Δ T max ) \times Tframe .$$

The processing unit 7 thus executes a servo loop in order to modify the integration time Tint1 and/or Tint2 and/or the image period Tframe of the sensor 5 such that the PRPs of the laser designator 2 are not included in the problematic cases defined by equation (1), with the above-stated new value of E, while adhering to the above formula ΔTint=Tframe−(Tint2−Tint1)/2.

For this purpose, the processing unit 7 relies on the target images supplied by the sensor 5, ensuring in particular that one designation mark is clearly visible for each ΔTmax.

Regardless of the strategy selected, and even if none of said strategies is applied but the sensor 5 is a sensor having an HDR acquisition function, the control means 10 preferably define the integration times Tint1 and Tint2 such that they do not have the same value. By way of example, one is a long integration time and the other is a short integration time, i.e. the short integration time is at least 1.5 times shorter than the long integration time, for example at least 2 times shorter. For example, Tint1 is a long integration time and Tint2 is a short integration time.

Having a long integration time makes it possible in particular to have more chances of being able to image the designation mark during the image period in question.

The images obtained during the first integration time Tint1 and during the second integration time Tint2 are then merged to generate a single image associated with the given image period.

This advantageously makes it possible to use longer integration times (which potentially generate partial saturations) in so far as any information which might be missing due to this saturation can still be acquired during the shorter integration time over the same image period.

The processing unit 7 is thus capable of executing one or more servo loops in order to control the optronic device 4, in particular the sensor 5 and/or one or more spectral filtering devices 9 of the optronic device 4, so as to ensure the time integration of at least one laser pulse over the predetermined given time interval and/or to optimise the detectability of said laser pulse.

For this purpose, the processing unit 7 relies on an analysis of the images generated by the apparatus 3 (and/or the data for managing those images).

What has thus been described is an apparatus 3 for observing a short-pulse laser designator 2 despite the apparatus 3 being asynchronous with the laser designator 2.

An apparatus 3 of this kind is compact.

An apparatus 3 of this kind is relatively inexpensive.

An apparatus 3 of this kind can operate just as well with a sensor 5 operating in black and white as with a sensor 5 operating in colour.

An apparatus 3 of this kind is simple to integrate in an existing apparatus.

An apparatus 3 of this kind is versatile and allows conventionally usable images to be supplied.

It goes without saying that the invention is not limited to the embodiments described above, and alternative embodiments can be applied thereto without departing from the scope of the invention as defined by the claims.

The spectral filtering device (whether it has a variable or fixed spectral width and whether it is removable or non-removable) could be associated with at least one attenuator filter—an attenuator filter outside the wavelength range [λ1; λ2] of the spectral filtering device.

At least one attenuator filter could itself be removable or non-removable.

At least one attenuator filter could itself be variable, i.e. have a variable spectral filtering bandwidth and/or have a variable filtering end value (in that it is replaced by another attenuator filter where there is a set of attenuator filters and/or in that it is oriented differently by virtue of the polarisation of the light at the filter and/or in that it is associated temporarily with another attenuator filter where there is a set of attenuator filters). The variability of the attenuator filter is preferably modified depending on the illumination level from the surrounding environment in order to adapt the light flux levels from the scene on the sensor.

It should be noted that if the spectral filtering device comprises at least one variable attenuator filter, the spectral filtering device will in turn be a spectral filtering device having variable attenuation (the device could also have a variable or fixed spectral width); it is sufficient to act on the variable attenuator filter in order to modify the optical flux reaching the sensor.

The spectral filtering device having the fixed spectral width could comprise two filters (one low-pass and one high-pass) instead of one band-pass filter. Equally, the spectral filtering device having a variable spectral width could comprise a single band-pass filter:
which has a fixed spectral width and is associated with at least one variable attenuator filter,
of which at least one of the terminals is variable (different orientation, replaced by or associated with at least one other filter, etc.).

Although the sensor here is a CMOS sensor, the sensor could be different and could, for example, be a CCD sensor (“charge-coupled device”).

The sensor could be configured so that the response of its pixels to the received radiation is indifferent (in the case of a monochrome sensor) or is graduated depending on an arrangement that uses a matrix of N micro-filters deposited in front of the sensor pixels (for example in the case of a colour sensor, which conventionally uses three types of filters that adapt the pixels to capture red, green and blue, or a colour sensor which uses four types of filters that adapt the pixels to capture red, green, blue and near infrared, or a panchromatic colour sensor, it being understood that there are variants on these arrangements of filters), provided of course that the arrangement is then transmissive to the emission wavelength of the laser designator.

The sensor could be controlled so that Tframe is equal to Tint to ensure that each designation mark (induced by each laser pulse generated by the laser designator) is imaged. Preferably, control of this kind is carried out only in the event of weak illumination from the surrounding environment (at night, for example). Preferably, however, it would be preferable for Tint to be strictly less than Tframe and for a strategy for controlling the sensor to be implemented to ensure that at least one designation mark can be imaged per predetermined time interval.

Although here Tint (or Tint1) starts at the same time as Tframe, there could be a delay between Tint (or Tint1) and Tframe (fixed or variable delay).

Although it is assumed here that a discrete and known list of PRPs is known, it can also be assumed that there is only one known PRP. The control means would then be able to modify at least one parameter of the sensor on the basis of this single known PRP value.

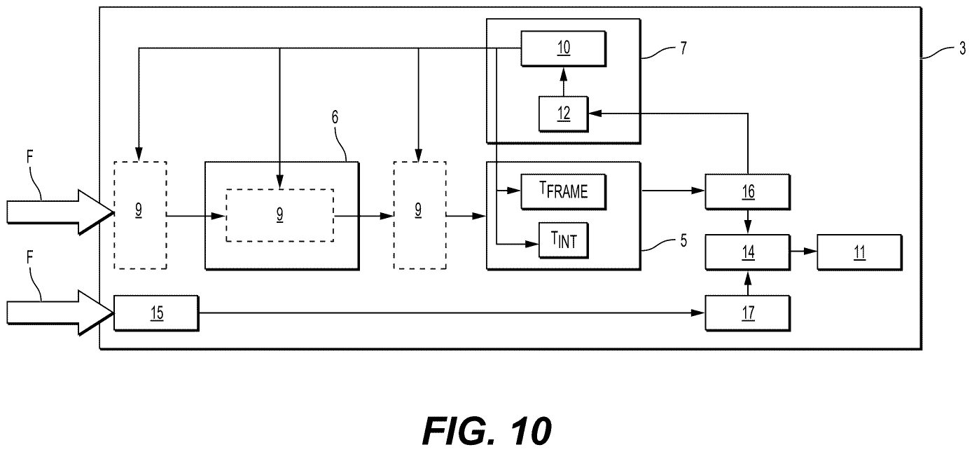

Although target images are generated in this case, the described apparatus and/or system could, in a manner known per se, also generate scene images and combine the scene images with the target images in order to integrate the designation marks detected in the target images and superimpose them onto the scene images. FIG. 10 shows a configuration of this kind, for which the scene image is obtained by means of an imaging sensor other than the on-silicon sensor. Optionally, the on-silicon sensor could be configured to take both the target image and the scene image. In the different cases, the target C could be present in the scene image and/or the target image.

The laser designator and the tracking apparatus could be borne by the same support and therefore be co-located. Alternatively, the laser designator and the tracking apparatus could be borne by two separate, spaced-apart supports so as not to be co-located. By way of example, the laser designator could be installed in a first aircraft and the tracking apparatus in a second aircraft, or the laser designator and the tracking apparatus could be borne by the same aircraft.

The term “aircraft” is used equally to mean an aeroplane, a drone, a helicopter, a launcher, a munition (missile or bomb) and, in general, any aerial vehicle that can move in the air.

1. An asynchronous system for designating at least one target, comprising at least one laser designator associated with at least one designation tracking apparatus, the apparatus comprising:
an optronic device having:
at least one optical imaging sensor, and
at least one imaging optic suitable for directing light rays onto a sensitive surface of the sensor,
a processing unit configured to analyse data transmitted by the sensor in order to determine a position of at least one designation mark generated by a laser designator intended to be associated with the designation tracking apparatus,
the sensor being an on-silicon sensor, the apparatus comprising sensor control means capable of modifying at least one parameter of the sensor in order, during operation, to image at least one designation mark generated by the laser designator per predetermined given time interval, said interval being repeated periodically,
the apparatus being asynchronous with the laser designator.

2. The system according to claim 1, wherein the sensor is a complementary metal-oxide semiconductor sensor.

3. The system according to claim 1, comprising at least one spectral filtering device arranged upstream of the sensor and suitable for increasing, during operation, a ratio between radiation intensity received from the laser designator and radiation intensity received from the surrounding environment.

4. The system according to claim 3, wherein the spectral filtering device is a spectral filtering device having a variable spectral width and/or variable attenuation.

5. The system according to claim 3, wherein the spectral filtering device is arranged upstream of the imaging optic and/or inside the imaging optic.

6. The system according to claim 1, wherein the control means execute at least one servo loop in order to modify the at least one parameter of the sensor on the basis of at least the data transmitted by the sensor.

7. The system according to claim 3, wherein the control means also control the spectral filtering device.

8. The system according to claim 1, wherein the parameter modified by the control means is an integration time of the sensor and/or an image period of the sensor.

9. The system according to claim 1, wherein the sensor comprises a function allowing for a plurality of integration times.

10. The system according to claim 1, wherein the laser designator is remote from the tracking apparatus or wherein the tracking apparatus is borne by the same support as the laser designator.

11. The system according to claim 1, configured to acquire a target image including a designation mark and a scene image and to merge the two images.
